(19) United States
(12) Patent Application Publication
(10) Pub. No.: US 2009/0157801 A1
(43) Pub. Date: Jun. 18, 2009

(54) System and method for integrating external system data in a visual mapping system

(76) Inventors: Richard Barber, Berkeley, CA (US); Peter Hizalev, San Francisco, CA (US); Andrew Mochalskyy, San Francisco, CA (US); Stefan Funk, Larkspur, CA (US)

Correspondence Address: Tina M. Lessani;Lessani & Lessani LLP, 163 Cypress Point Road, Half Bay Moon, CA, 94019, US

(21) Appl. No.: 12/001,520

(22) Filed: Dec. 12, 2007

(51) Int. Cl. G06F 15/16

(52) U.S. Cl. 709/203

(57) ABSTRACT

The present invention provides an improved system and method for integrating external system data into a visual map. The visual mapping system of the present invention is based on a client-server architecture. A server in the visual mapping system communicates with one or more external systems to import data from such external systems. The server organizes the data into topics for a visual map and stores the topics individually in a database. The server provides the topics to a client visual mapping application to enable users to view external system data through a visual map. The client visual mapping application need not be running for the server to obtain the external system data, and, thus, the present invention provides “backend” integration of external system data. The server can also export data in topics to external systems.

### BACKGROUND OF THE INVENTION

1. Field of the Invention

This invention relates generally to visual mapping systems, and, more particularly, to a visual mapping system that can exchange data with external data sources.

2. Description of the Background Art

A visual map is a diagram that represents ideas and/or information in topics. Examples of visual maps are mind maps, topic maps, semantic networks, and concept maps. Visual maps are increasingly used to help people generate, classify, and/or organize ideas and information and to see such ideas and information in a hierarchical, visual layout.

Visual maps are used for project management, work-flow analysis, organizational charts, and other purposes. FIG. 1 is an example of a visual map for information related to a wireless communication project meeting. The visual map in FIG. 1 is a mind map. Mind maps are made up of hierarchically-arranged topics. The main topics in FIG. 1 are “Action Items”, “Purpose”, “Agenda”, “Time Place”, “Participants”, and “Purpose.” Each of these topics has subtopics. For instance, “Implementation” is a subtopic for “Action Items,” and “Carry out Launch” is a subtopic of “Implementation.”

There are software programs that enable people to easily create visual maps. Mindjet Corporation's MindManager® software is an example of such software. In known visual mapping software applications, users create topics in a visual map by inserting or importing texts and graphic elements into topics.

It is often desirable to integrate data from an external data source into a visual map. It can be easier to view and digest information from an external data source in the context of a visual map because the visual map provides a graphical display of information. It also is often desirable to export data in a visual map to an external data source.

There is a need for a visual mapping system that can import data from and export data to an external data source on the “back-end” without the user having to initiate the data exchange in real-time through a visual map. There is also a need for a system that allows topics with external system data to be stored and searched separately from a visual map file and to be accessed by multiple users.

### SUMMARY

The present invention provides an improved system and method for integrating external system data into a visual map. The visual mapping system of the present invention is based on a client-server architecture. The visual mapping system includes at least one server and at least one client visual mapping application through which a user can view, create, and edit visual maps. The server manages the storage and retrieval of maps and topics in the visual mapping system.

The server obtains data from an external system, where the data can be “pushed” to the server by the external system or the data can be “pulled” from the external system by the server (e.g., the server can send a request to the external system for data satisfying certain criteria). The server organizes the data from the external system into topics. It then stores the topics in the database (where “storing” the topic can include instructing a database server to store the topics). The topics are stored individually in the database so that they can be separately searched and retrieved. The server provides the topics to the client visual mapping application when the user requests the topics. The server also can export to an external system data that a user inputted into a topic.

The client visual mapping application does not need to be running for the server to import data from or export data to an external system. In other words, data exchange with external systems happens on the “back-end” and does not require the user to be using the visual mapping system at the time of the data exchange. This way external system data can be ready for the user to view in a visual map the next time a user opens a visual map. Because the server can both import and export data, the present invention can be used to enable a user to exchange data with multiple external systems via a visual map interface.

Because topics are stored individually in a database, topics with external system data can be shared across multiple visual maps by multiple users. The topics are indexed so that they can be easily searched by users.

### BRIEF DESCRIPTION OF THE DRAWINGS

FIGS. 1 is an example of a mind map.

FIG. 2 is a flow chart that illustrates a method for importing information from an external system.

FIGS. 3a-b are a flow chart that illustrates a method for exporting data to an external system.

FIG. 4 is a block diagram of an example visual mapping system according to one embodiment of the present invention.

FIGS. 5a-5c are tables that illustrate an example of how topics are stored in a database.

FIGS. 6a-6c are tables that illustrate an example of how workspaces are stored in a database.

FIGS. 7-8 are example visual maps discussed in conjunction with FIGS. 5a-5c and 6a-6c.

FIGS. 9, 10, and 11 are example visual maps that incorporate data from a travel website.

FIGS. 12a-12b are a flow chart that illustrates how a visual mapping system can create the visual maps shown in FIGS. 10a-b and 11.

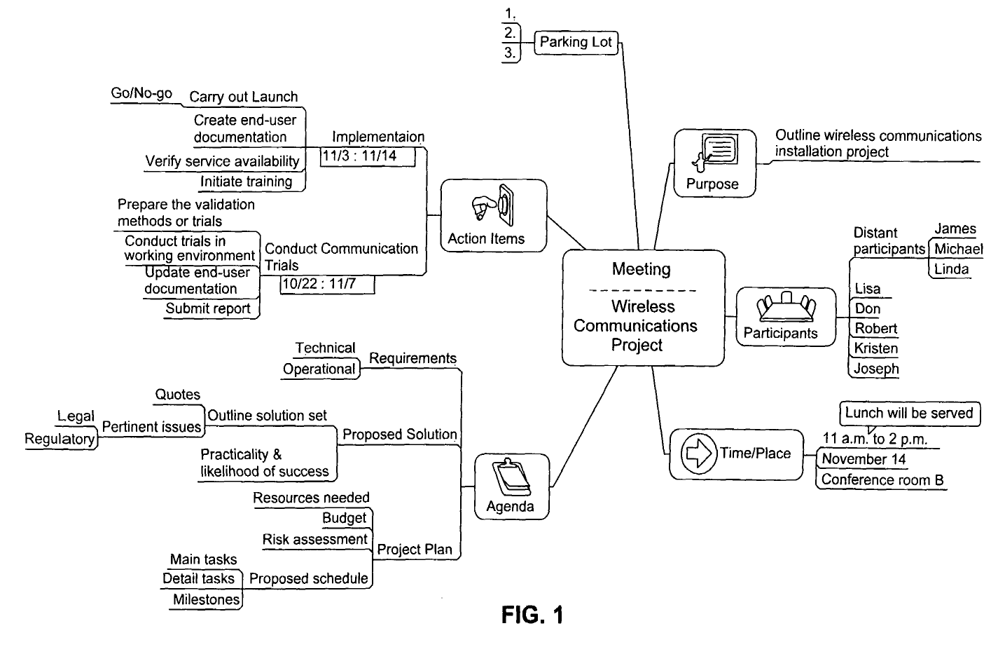

### DETAILED DESCRIPTION OF THE PREFERRED EMBODIMENTS

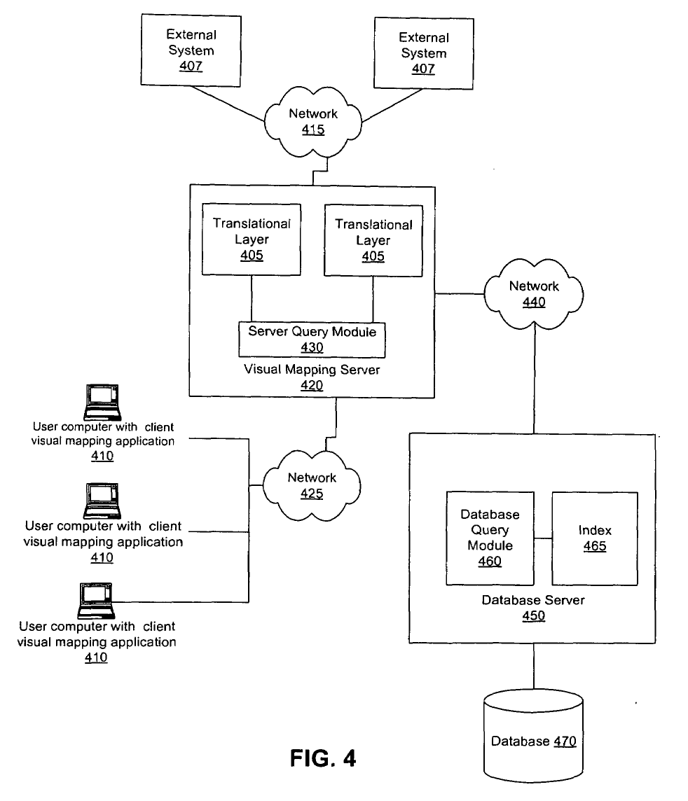

The visual mapping system of the present invention is based on a client-server architecture which includes at least one server and one client visual mapping application. Users create, view, and edit visual maps through a client visual mapping application that communicates with a server in the visual mapping system. The server manages the storage and retrieval of topics in a visual map and provides them to client visual mapping applications upon request. FIG. 4, which will be discussed in more detail below, illustrates an example of a visual mapping system with a client-server architecture.

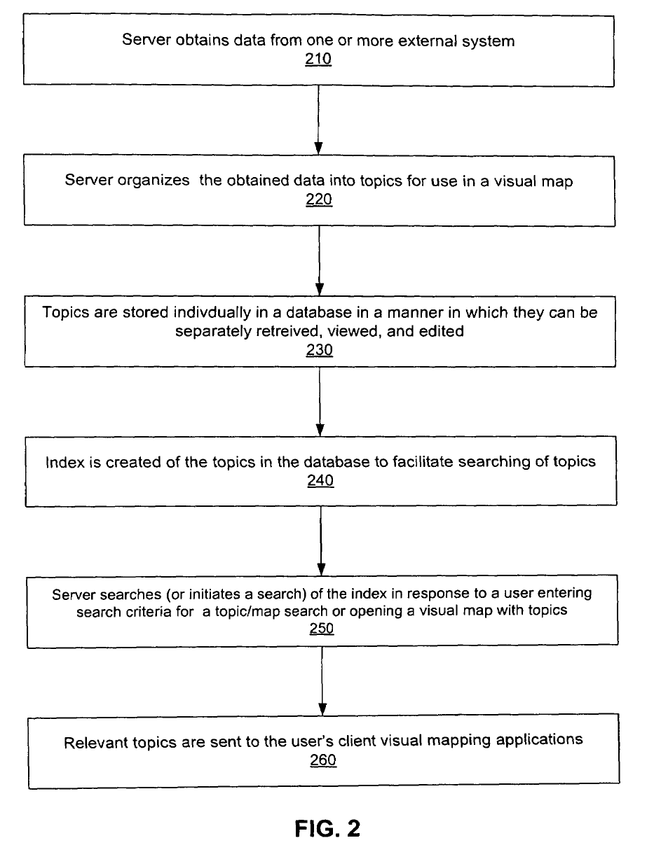

FIG. 2 illustrates a method in which a client-server based visual mapping system imports data from an external system into topics that can be used in one or more visual maps. A server in the visual mapping system obtains data from one or more external systems (210). The data import may be initiated by the server (i.e., the server “pulls” data from the external system) or by the external system (i.e., the external system “pushes” data to the server). The server organizes the obtained data into topics for use in a visual map (220) and stores each of the topics individually in a database (230). Each topic is stored as a separate entry in the database so it can be separately searched, viewed, and edited. An index is created of the topics in the database to facilitate searching of topics in the database (240).

The server searches (or initiates a search) of the index in response to a user entering search criteria for a topic/map search or opening of a visual map with topics (250). The relevant topics are then sent to the user's client visual mapping application (260).

The server communicates with external systems independent of the client visual mapping applications. In other words, the client user application need not be running for the server to import data from an external system. The server is running applications to import and/or export data on its own, thereby providing “back-end” integration of data from external systems. This way large amounts of data can be imported and organized into topics while the user is doing something else, and, when the user interfaces with the visual mapping system through a client visual mapping application, the server is ready to search for and retrieve topics and maps with external system data.

Because topics are stored individually, they can be used in different maps and by different users. By integrating external system data into topics that can be shared across multiple maps and users, the visual mapping system does not have to repeat requests for the same external system data for each user. If a topic with requested external system data already exists and the user has access rights to the topic, then the server in the visual mapping system can simply retrieve such topic from the database instead of having to re-obtain the data from the external system.

An external system is a system or software application that is external to the visual mapping system. There are many different type of external systems from which the server in the visual mapping system can retrieve data. The server can search websites for data to import. The server also can import data from various business enterprise systems, such as project management systems, accounting systems, Customer Resource Management (CRM) systems, Enterprise Resource Planning (ERP) systems, contact information systems, etc. Data from more than one external system can be inserted into a topic. In one embodiment, the server in the visual mapping system can search websites or request data from business systems based on criteria previously enter by a user through a client visual mapping application or by a system administrator through a configuration tool that interfaces with the server.

Data can be imported into topics that are tailored to display a specific type of content in a certain way. For instance, the data can be imported into “content-specific topics” described in U.S. patent application Ser. No. 11/478,220 titled “System and Method for Providing Content-Specific Topics in a Mind Mapping Application” filed on Jun. 29, 2006 with inventors Michael B. Jetter, Richard Barber, Michael Scherotter, Stefan Funk, Andrew Mochalasy, and Peter Hizalev, the contents of which are incorporated by reference as if fully disclosed herein.

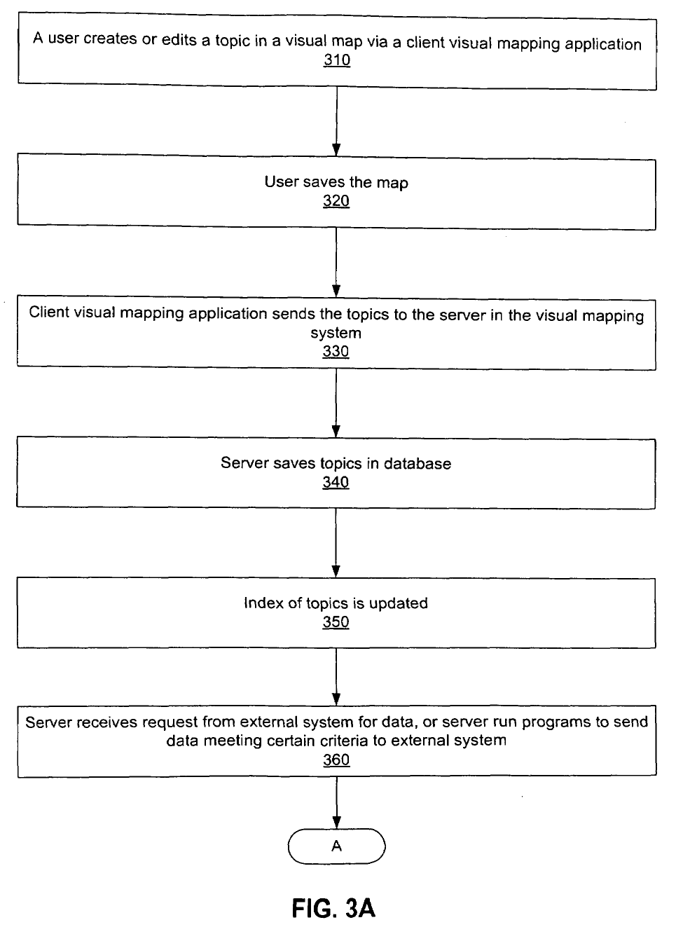

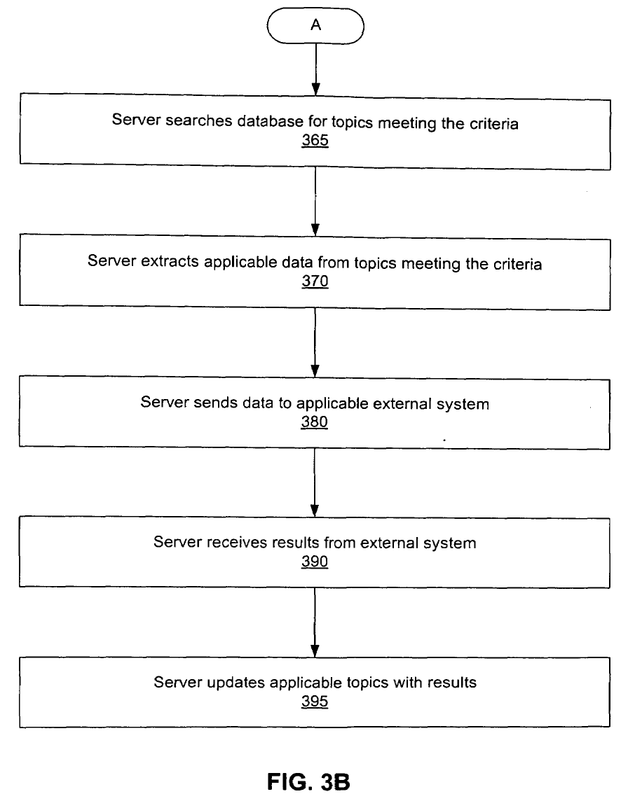

FIG. 3 illustrates one way in which a client-server visual mapping system can export data from one or visual maps to one or more external systems. In this embodiment, a user creates or edits a topic in a visual map via a client visual mapping application (310). The user saves the map (320), and the client visual mapping application sends the topics to a server in the visual mapping system (330). The server saves the topics individually in the database (or for existing topics, updates the database with any changes) (340). The index of topics in the database is then updated (350).

The server may export data in the topics in response to a request from an external system for data meeting certain criteria (360). In such case, the server searches the database for topics meeting the criteria of the request (365). Alternatively, the visual mapping system may run programs to send data meeting certain criteria to external systems (360). In such case, the server may periodically search for topics meeting such criteria (365). For instance, the visual mapping server may be programmed to perform searches at certain times or certain intervals. The server may also export data based on criteria entered by a user or a system administrator.

In response to finding topics meeting the search criteria, the server extracts the applicable data from such topics (370) and sends it to the applicable external system(s) (380). The external system may send a response back to the server, and, if so the server receives the results (390), and updates the applicable topics with the results (395). The next time a user views the topics, the user will see the updated version of the topics.

FIG. 4 is a block diagram of an example visual mapping system according to one embodiment of the present invention. The system includes a client visual mapping application 410 that runs on users' computers, a visual mapping server 420, a database server 450, and a database 470. The visual mapping server 420 includes a server query module 430. The server query module 430 communicates with client visual mapping applications 410 to send and receive topics to client visual mapping applications 410. When the server query module 430 receives topics created by users from client visual mapping applications 410, the server query module 430 sends the topics to a database query module 460 on the database server 450, which stores the topics in the database 470. The database query module 460 creates and maintains and index 465 of the topics stored in the database 470.

When a user searches for a map or a topic, the user's client visual mapping application 410 sends the search criteria to the server query module 430. The server query module 430 formulates a search query for the applicable topics and sends the query on to the database query module 460, which searches the index 465 for topics meeting the search criteria. A list of topics/maps meeting the search criteria is then sent to the server query module 430, which forwards the list to the applicable client visual mapping application 410. If a user wants to load a topic or map from the list into the client visual mapping application 410, the client visual mapping application 410 requests the topic/map from the server query module 430, which then formulates an applicable query for the database query module 460. The database query module 460 retrieves from the database 470 the requested topic, or in the case of a map, the topics in the map, and sends them to the server query module 430, which passes them on to the applicable client visual mapping application 410. More details of how a user can search and retrieve topics and visual maps in the visual mapping system are described in the co-pending application titled “System and Method for Enabling a User to Search and Retrieve Topics in a Visual Map on an Individual Basis,” filed on Dec. 12, 2007 with inventors Richard Barber, Peter Hizalev, Andrew Mochalskyy, and Stefan Funk, the contents of which are incorporated by reference as if fully disclosed herein.

In one embodiment, the sever query module 430 communicates with the database server 450, the client visual mapping applications 410, and external systems 407 via networks 440, 425, and 415, respectively. These networks may be the same network or different networks. They may a private network or the Internet (or a combination of both).

The server query module 430 organizes data from external systems 407 into topics and forwards the topics onto the database query module 460 for storage in the database 470. When data is to be sent to an external system 407 (either by the request of the visual mapping system or an external system), the server query module 430 formulates a query request with search criteria for topics, and sends the query to the database query module 460, which then searches the database 470 for topics meeting the search criteria.

Translational layers 405 enable the server query module 430 to communicate with external systems. Each translational layer 405 formats communications from an external system into a format understandable by the server query module 430. Similarly, each translational layer 405 formats communications from the server query module 430 into a format understandable by the applicable external system 407.

A client visual mapping application 410 may be a software application running on a user's computer or may be a browser-based application (where a user interfaces with the visual mapping server 420 through a web browser).

In one embodiment, the server query module 430 communicates with the database query module 460 in XML or SOAP, and the database query module 460 communicates with the database using SQL.

Those skilled in the art will appreciate that FIG. 4 illustrates one example of a visual mapping system of the present invention and there are other ways to implement a visual mapping system with a client-server architecture. For instance, there could be multiple servers serving the client visual mapping applications 410. Moreover, the server query module 430 and the database query module 460 could reside on the same server. Furthermore, topics can be stored in more than one database (e.g., there can be multiple databases connected through a network).

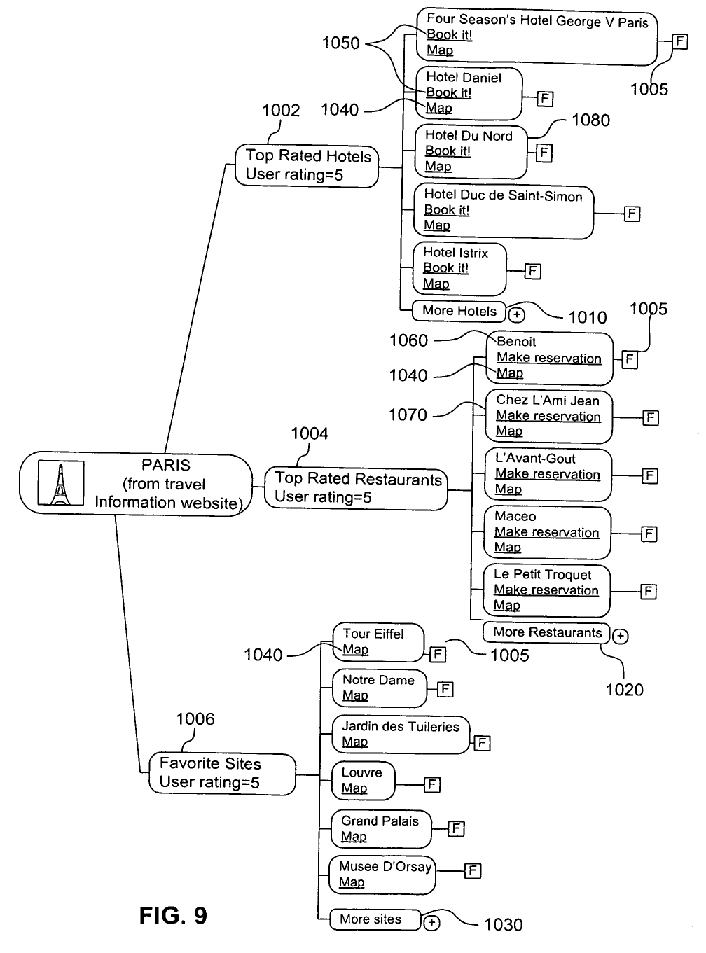

FIG. 9 is an example visual map (in particular, a mind map) that illustrates data retrieved from a website with travel information. The mind map show hotels, restaurants, and sites in Paris that have a user rating of “5” on the travel website (where 5 represents the top rating). To view all this data on a website, a user would have to click through multiple web pages. The mind map illustrated in FIG. 9 allows user to easily see the top-rated hotels, restaurants, and favorite sites. Hotels, restaurants and sites are organized under topics 1002, 1004, 1006, respectively. Next to each topic is a hyperlink 1005 to the page on the travel website that provides a description of the corresponding hotel, restaurant, or site. By clicking on the hyperlinks 1005, a user can read more about each hotel, restaurant, and site. A user can expand the list of hotels, restaurants, and sites by expanding topics 1010, 1020, and 1030, respectively.

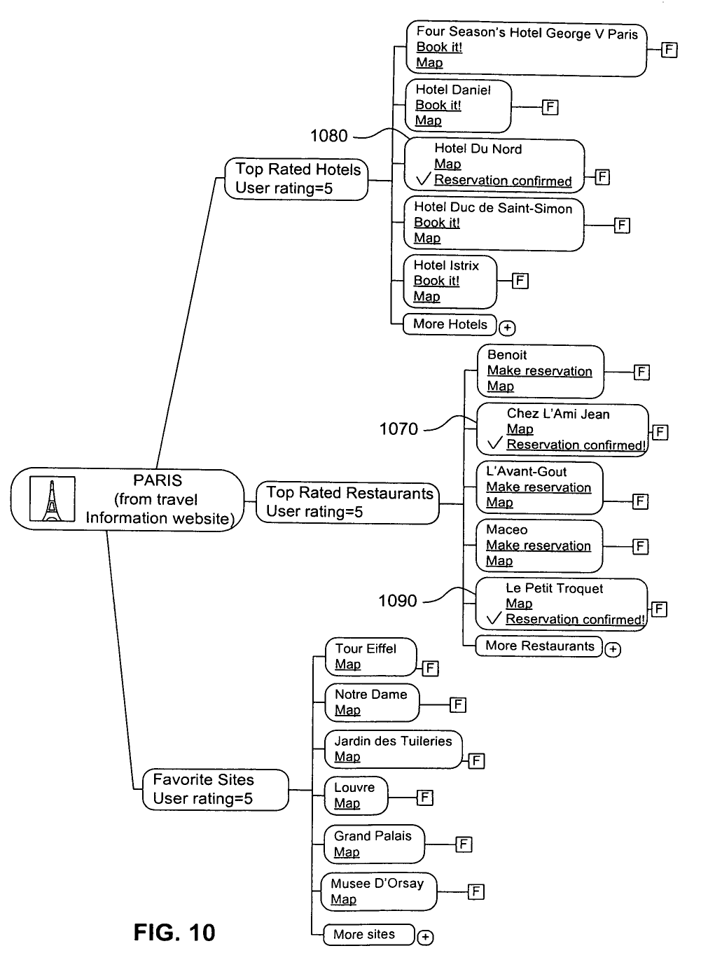

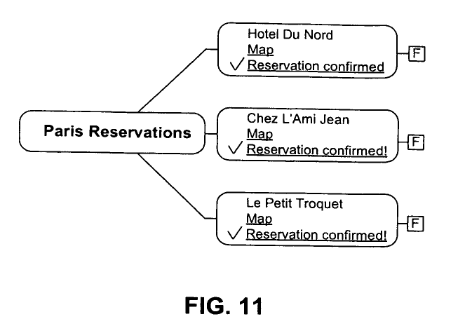

A user can select the “map” link 1040 in each topic to see a map that illustrates the location of the applicable hotel, restaurant, or site. Users can also make a reservation at a hotel or restaurant by clicking on the “book it” or “make a reservation” links 1050, 1060. Clicking on a link pulls up a form in which a user enters the desired dates, time, and other information necessary to make a reservation (in an alternate embodiment, the link can take a user directly to an external reservation website). After a reservation is made and confirmed, the map is updated to show that a reservation is made, as shown in FIG. 10. Before the user leaves for his trip, he can perform a search for topics where a reservation has been confirmed and view those topics in another map, such as the map shown in FIG. 11.

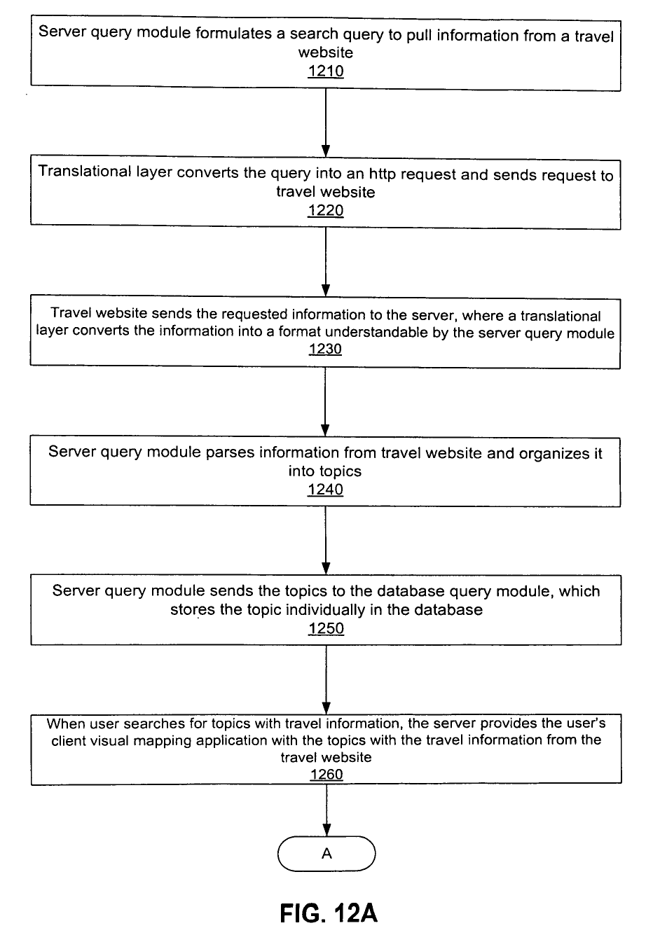

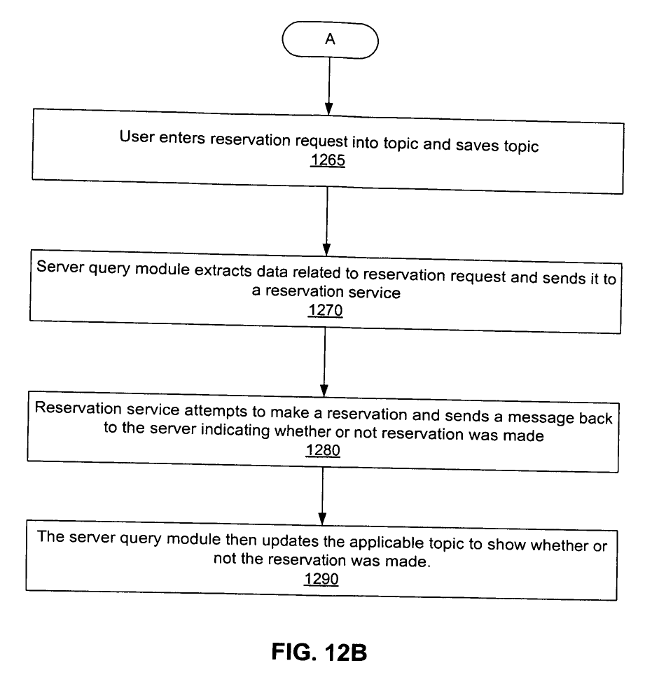

The flowcharts in FIG. 12a-12b illustrate how the visual mapping system illustrated in FIG. 4 can work to create the visual maps shown in FIGS. 10a-b and 11. The server query module 430 formulates a search query to pull information from a travel website (1210). Such a request may be based on a program run by the server 420 or on search criteria previously entered by a user or system administrator. In this example, the search query is for hotels, restaurants, and sites in Paris that have a user rating of 5. A translational layer 405 converts the query into an http request and sends it to the travel website (1220). The travel website sends the requested information to the sever 420, where a translational layer 405 converts the information into a format understandable to the server query module 430 (e.g., XML) (1230). The server query module 430 parses through the information and organizes the information into the topics shown in FIG. 10a (1240). The topics may be a class of topics that are designed specifically for display of travel information (i.e., they may be the “content-specific” topics discussed above). The server query module 430 sends the topics data to the database query module 460, which stores the topics individually in the database 470 (1250). When a user searches for topics with travel information on Paris (via the client visual mapping application), the server 420 provides the user's client visual mapping application 410 with topics shown in FIG. 10a (1260). Because the server 420 was able to retrieve the information from the travel website on its own (i.e., on the backend), the information is ready for the user whenever the user wants to view it. The user does not have to wait for a search to be performed. Moreover, multiple users can share these topics, and, therefore, search for this travel information does not have to be performed for each user that requests the data.

If a user enters data for making a hotel or restaurant reservation, the data is saved with the applicable topics. In one embodiment, when a user saves a topic with a reservation request (1265), the server query module 430 extracts the applicable reservation data and sends it to a reservation service via a translational layer 405 (1270). The reservation service may be different from the travel website from which the travel information was retrieved and, thus, the translational layer 405 may be different than the translational layer referenced in step 1220. The reservation service then attempts to make the reservation and sends a message back to the server 420 indicating whether or not the reservation was made (1280). The server query module 430 then updates the applicable topic to show whether or not the reservation was made (1290). If the user is viewing the topic at the time the topic is updated, the server query module 430 dynamically updates the user's client visual mapping application 410 so that a user can immediately see the change. If the user has already closed the map with the topic, the user will see the results the next time the user loads the topic through which the user made the reservation request (topics 1070, 1080 and 1090 in FIG. 10a). In FIG. 10b, topics 1070, 1080, and 1090 show that a reservation was successfully made for the hotel and restaurants associated with such topics.

The present invention also can be used to support workflow between external systems. For example, a user can view a visual map with data from a CRM system. The topics in the map can be configured to display invoice information and provide an interface through which a user can approve invoices. If a user approves an invoice through the visual map, then notice of the approval can be sent to an external accounting system.

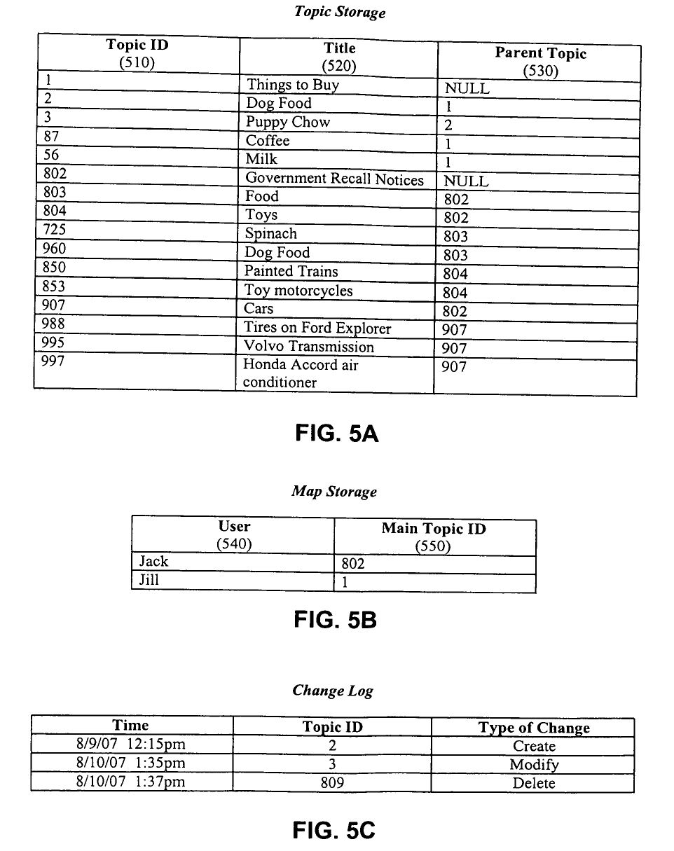

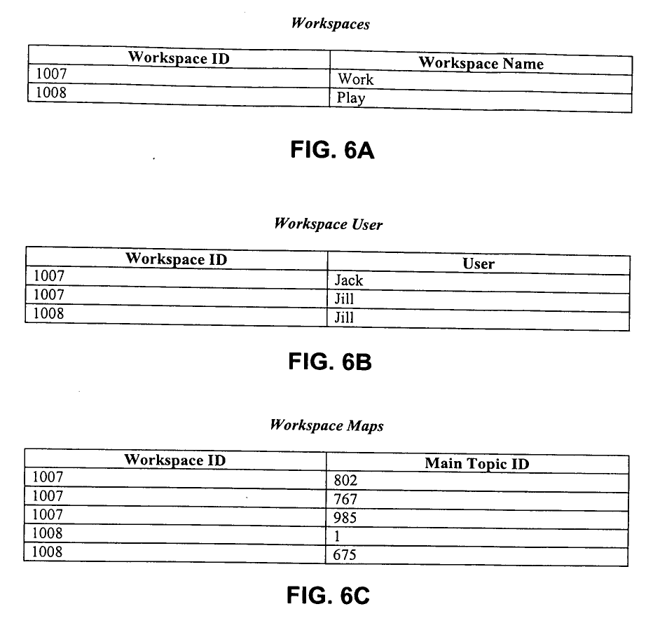

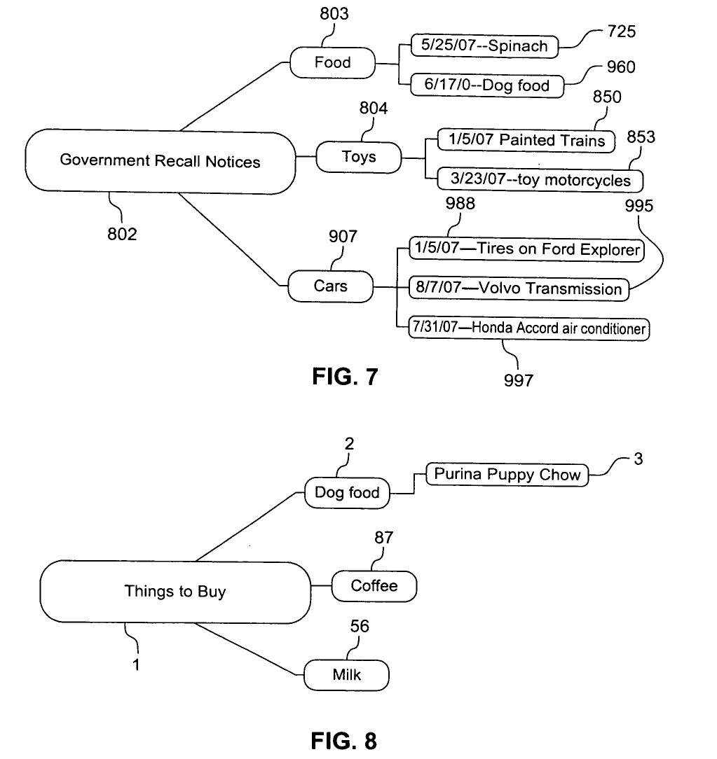

FIG. 5a-5c and 6a-6b are example, simplified tables that illustrate how topics, maps, and workspaces can be stored in a database. These examples are described with respect to the example maps in FIGS. 7 and 8. In the illustrated embodiment, topics are stored in tables. FIG. 5a is an example of a table for storing maps. The table includes a column for topic ID 510, topic title 520, and the parent topic ID 530. Each topic is associated with a unique ID. For the purposes of this example, the reference numbers in FIGS. 7 and 8 are the same as the unique IDs. Column 510 stores the topic ID, column 520 stores the title of the topic, and column 530 lists any direct parent topic of a topic. For instance, the central topic “Things to Buy” in FIG. 8 has topic ID “1”. Since it does not have a parent topic, “NULL” is in the database entry for the Parent Topic column 530. The topic “3” called “Purina Puppy Chow” has the topic “Dog Food” with topic ID “2” as a parent, and, therefore, “2” is the entry in Parent Topic ID column 530 for the “Purina Puppy Chow” topic 3. FIG. 5a shows only three columns for simplicity purposes, but the topic table could store much more information about topics and have many more columns, such as columns that have flag information, topic class information, comments, the date created, etc.

FIG. 5b illustrates an example of how maps are stored. In this embodiment, a map is just the central or primary topic in the map from to which all other topics directly or indirectly connect. The table in FIG. 5b has two columns. Column 540 lists the users that created each map, and column 550 lists the topic ID of the main topic in the visual map. In this example, user Jack has created the map “Government Recall Notices” where the primary topic has topic ID “802.” User Jill has created the map “Things to Buy” where the primary topic has topic ID “1.”

FIG. 5c illustrates a Change Log table. The Change Log table lists each change associated with a topic. For instance, the table shows that the topic with topic ID “2” (“Dog Food” in FIG. 8) was created at 12:15 pm on Aug. 9, 2007. The table also shows that the topic with topic ID “3” (“Purina Puppy Chow” in FIG. 8) was modified at 1:35 pm on Aug. 10, 2007, and that a topic with topic ID “809” was deleted at 1:37 pm on Aug. 10, 2007. The Change Log table enables users to see the change history of each topic. FIG. 5c illustrates a simple Change Log table, but Change Log table could include much more detail about changes. For instance, there could be a “user” column that indicates who made the change, and there could be a column that specifies the details of the change.

In one embodiment, the visual mapping system supports workspaces, where users belonging to a workspace can share documents in the workspace. Workspaces are assigned IDs, and FIG. 6a illustrates a table database that relates a workspace ID to its name. In this example, there are two workspaces, one labeled “Work” and one labeled “Play”. FIG. 6b illustrates table that stores the names of users that are associated with each workspace. Both Jill and Jack belong to the workspace “Work” and Jill belongs to the workspace labeled “Play.”

FIG. 6c is a table that relates each workspace to a map by relating each workspace to the main topic ID for the map (e.g., the central topic). In this example, workspace “1007” (“Work”) includes maps having main topic IDs “802,” “764” (map not shown), and “985” (map not shown). Workspace “1008” (“Play”) includes maps having main topic IDs “1” and “675” (map not shown).

As will be understood by those familiar with the art, the invention may be embodied in other specific forms without departing from the spirit or essential characteristics thereof. Accordingly, the above disclosure of the present invention is intended to be illustrative and not limiting of the invention.

1. A method for integrating external system data into topics in a visual mapping system, where the system includes (1) a server that manages the storage and retrieval of topics for visual maps and (2) a client visual mapping application through which the user can create, view and edit visual maps, the method comprising:
obtaining data from an external system, where the data is obtained by the server and where the client visual mapping application does not need to be running for the server to obtain such data;
organizing the data into topics, where the server organizes the data into topics;
storing the topics individually in a database, where topics are stored in a manner that enables the topics to be separately retrieved, viewed, and edited;
indexing the topics to facilitate searching of the topics; and
providing one or more of the topics to the client visual mapping application in response to a request from the client visual mapping application to enable the user to view the data from the external system in the form of a visual map, where the server provides such topics to the client visual mapping application.

2. The method of claim 1, wherein the external system is a web server.

3. The method of claim 1, wherein the data is obtained by periodically searching a website associated with the external system.

4. The method of claim 1, where the external system is a remote server for a business organization.

5. The method of claim 1, wherein the step of obtaining the data includes periodically sending requests to the external data source for data.

6. The method of claim 1, wherein the external system is a CRM system.

7. The method of claim 1, where the external system is an ERP system.

8. The method of claim 1, wherein the external system is an accounting system.

9. The method of claim 1, wherein the external system is a project management system.

10. The method of claim 1, further comprising enabling the user to modify topics that include external system data.

11. The method of claim 10, further comprising, if the user modifies a topic with external system data, updating such topic in the database to reflect the user modifications.

12. The method of claim 11, further comprising sending the modifications to the external system for the external system to perform an action with respect to such modifications.

13. The method of claim 11, further comprising sending the modifications to a second external system for the second external system to perform an action with respect to such modifications.

14. The method of claim 1, wherein data is obtained from the external system based on search criteria entered by a user.

15. The method of claim 1, wherein data is obtained from the external system based on search criteria entered by a system administrator.

16. The method of claim 1, wherein the step of providing one or more topics includes:
receiving at the server search criteria for topics from the client visual mapping application;
searching the index for topics meeting the search criteria; and
providing topic meeting the search criteria to the client visual mapping application. searching the index for topics meeting search criteria specified by the client visual mapping application.

17. The method of claim 1, wherein the topics can be shared across a plurality of users.

18. The method of claim 1, wherein the topics can be shared across a plurality of visual maps.

19. The method of claim 1, wherein the server obtains data from a plurality of external systems.

20. The method of claim 19, wherein one or more the topics includes data from a plurality of external systems.

21. A method for exporting data from a visual mapping system to an external system, where the visual mapping system includes (1) a server that manages the storage and retrieval of topics for visual maps, (2) a client visual mapping application through which the user can create, view and edit visual maps, and (3) a database where topics are stored individually, the method comprising:
searching the database for topics meeting certain criteria, where the search is managed by the server and where the client visual mapping application need not be running for such search to be performed; and
for each topic meeting the criteria, performing the following:
extracting data from such topic, where the server extracts the data;
sending the data to the external system, where the server sends the data;
receiving a response from the external system, where the server receives the response;
updating the topic with the response; and
in response to receiving a request from a client visual mapping application for the topic, providing, by the server, the updated topic to the client visual application.

22. The method of claim 21, wherein the search of the database is based on a search request from the external system.

23. The method of claim 21, wherein the search of the database is based on a program run by the server.

24. The method of claim 21, wherein the search of the database is based on criteria entered by a user.

25. A visual mapping system comprising:
a client computer with a client visual mapping application that provides an interface through which a user can view, edit, and create visual maps and through which a user can enter search criteria to search for one or more topics;
a database for storing topics in visual maps, where the topics are stored individually; and
a server connected to the client computer, the database, and the external system, wherein the server obtains data from the external system, organizes the data into topics, stores the topics individually in a database, and provides one or more of the topics to the client visual mapping application in response to a request from the client visual mapping application to enable the user to view the data from the external system in the form of a visual map.

26. The visual mapping system of claim 25, wherein the server also sends data from topics to the external system.

27. A computer program embodied on a computer-readable medium and comprising code, that, when executed by a computer, enables the computer to perform the following method:
obtaining data from an external system;
organizing the data into topics;
storing the topics individually in a database, where topics are stored in a manner that enables the topics to be separately retrieved, viewed, and edited;
indexing the topics to facilitate searching of the topics; and
providing one or more of the topics to a client visual mapping application in response to a request from the client visual mapping application to enable the user to view the data from the external system in the form of a visual map.
